(19) United States
(12) Patent Application Publication
(10) Pub. No.: US 2019/0058993 A1
(43) Pub. Date: Feb. 21, 2019

(54) WLAN AUTHENTICATION FOR LWA CONNECTION WITH LEGACY WI-FI DEPLOYMENT

(71) Applicant: MEDIATEK INC., Hsin-Chu (TW)

(72) Inventor: Meng-Hsiu Yu, Taipei City (TW)

(21) Appl. No.: 15/976,375

(22) Filed: May 10, 2018

Related U.S. Application Data
(60) Provisional application No. 62/546,037, filed on Aug. 16, 2017.

(51) Int. Cl. H04W 12/06; H04W 12/04; H04W 12/08; H04W 48/16; H04W 84/04

(52) U.S. Cl. CPC H04W 12/06; H04W 12/04; H04W 84/12; H04W 48/16; H04W 84/045; H04W 12/08

(57) ABSTRACT

System and method of WLAN authentication enabling a user equipment (UE) to automatically and autonomously detect an authentication protocol to gain access to a specified wireless local area network (WLAN) and thereby use Long-Term Evolution (LTE)-WLAN Aggregation (LWA) for data transmission. During LWA activation, the UE receives an instruction from an LTE control station to connect to a specific WLAN access point (AP), and in response starts to perform a set of authentication processes configured according to different authentication protocols until one that results in successful authentication. In this manner, the UE can determine an authentication protocol used by a WLAN AP even when the LTE control station is incapable of providing adequate information for purposes of WI-FI authentication.

### CROSSREFERENCE TO RELATED APPLICATION

This patent application claims priority and benefit of U.S. Provisional Patent Application No. 62/546,037, entitled “LWA CONNECTION WITH LEGACY WI-FI DEPLOYMENT,” filed on Aug. 16, 2017, the entire content of which is herein incorporated by reference for all purposes.

### TECHNICAL FIELD

Embodiments of the present disclosure relate generally to the field of wireless network communication, and more specifically, to the field of wireless communication by aggregating a cellular network and a wireless local area network (WLAN).

### BACKGROUND OF THE INVENTION

Long-Term Evolution (LTE)-wireless local area network (WLAN) Aggregation (LWA) is a technology defined by the 3^{rd} Generation Partnership Project (3GPP) organization. In LWA operations, a user equipment (UE) supporting both LTE and Wi-Fi may be configured to utilize both types of links simultaneously under the control of the LTE network. Typically data traffic offloading can be achieved by splitting and converging data through the LTE and WI-FI bearers in layer 2. LWA allows the LTE network to seamlessly and effectively integrate the WLAN as a new Radio Access Network (RAN) into its network and to offload data traffic to the Wi-Fi channels of the WLAN. Therefore, LWA offers significantly enhanced network capacity and performance gains.

LTE networks use Evolved NodeBs (eNBs) as base stations to manage radio resource and mobility to optimize all the UE's communication in a flat radio network structure. In LWA, an eNB is responsible for LWA control functionalities, including LWA activation, deactivation and the decisions as to which bearers are offloaded to the WLAN. To activate LWA for a UE, the eNB sends a request to a UE to perform a WI-FI scan, and the UE feeds back the scan results to the eNB in measurement report. Based on the report, the eNB instructs the UE to connect to a specified WLAN through a specific AP. In response, the UE executes an authentication process to request access to the WLAN. Once authenticated, the UE can establish connection with the WLAN and LWA is activated accordingly.

3GPP defines two WLAN authentication protocols specifically for LWA: (1) Wi-Fi Protected Access (WPA) Pre-Shared Key Protocol (PSK) and (2) LWA-specific Extensible Authentication Protocol (EAP-LWA). Both protocols require upgrade on, or even replacement of, current WI-FI access point (AP) deployments, which can impose significant cost to the LTE network service suppliers (or “operators” herein). Moreover, for the PSK protocol, weight counter/security key (S-Kwt) maintenance needs a new interface implementation between the eNB and a WI-FI AP, which may also contribute to additional LWA deployment cost.

In existing WLAN deployments, LTE operators commonly use one of the EAP protocols for better policy and charging management and user experience, including EAP-Subscriber Identity Module (EAP-SIM), EAP-Authentication and Key Agreement (EAP-AKA) and EAP-Authentication and Key Agreement prime (EAP-AKA′). It is desirable that these EAP protocols can continue to be used in the current WLAN deployments. Unfortunately according to 3GPP, neither LWA activation signal messages nor WI-FI scan results provide indication of which of the EAP methods is used for a specified WLAN. That is, for most of the existing WLAN deployments, there is no mechanism for the UEs to be aware of which particular EAP authentication process should be used to gain access to as specified WLAN.

### SUMMARY OF THE INVENTION

Accordingly, disclosed herein are embodiments directed to mechanisms that enable a user equipment (UE) to autonomously and automatically detect a wireless local area network (WLAN) WLAN authentication protocol used to gain access to a specific WLAN, and thereby Long-Term Evolution (LTE)-wireless local area network (WLAN) Aggregation (LWA) can be activated for the UE.

Embodiments of the present disclosure utilize an authentication selection process that involves a UE sequentially executing a plurality of authentication methods until successful authentication is achieved, where each authentication method corresponds to a different authentication protocol. In an exemplary embodiment, the plurality of authentication methods include EAP -Subscriber Identity Module (EAP-SIM), EAP-Authentication and Key Agreement (EAP-AKA), EAP-Authentication and Key Agreement prime (EAP-AKA′) and EAP-LWA. For instance, to activate LWA, an Evolved NodeB (eNB) sends a message to a UE with an instruction to establish connection with a specified WLAN access point (AP), whereas the message provides inadequate indication as to which specific authentication method is accepted by the AP. During an authentication selection process, the user equipment (UE) first executes an EAP-SIM process in attempt to gain access to the WLAN. If the authentication fails, the UE executes an EAP-AKA process and, if fails again, then it executes an EAP-AKA′ process. Following a successful authentication, the configuration and other related information used in the authentication process can be stored in a database for future retrieval and use. In some embodiments, the authentication selection process is invoked in response to failure to acquire effective authentication protocol information from the eNB instruction message.

An authentication selection process allows a UE to autonomously and intelligently determine an authentication protocol used on an AP despite lack of adequate information provided by an eNB node and WI-FI measurements. This can advantageously and remarkably expand a UE's opportunity and capability of discovering an accessible WLAN and of taking the benefit of LWA. LTE operators can benefit from continued use of the legacy WLAN infrastructure that has been configured with EAP-SIM, EAP-AKA and EAP-AKA′ to deploy LWA without the need to upgrade. Also, the selection process can be performed transparent to users as it does not require user input or other user intervention. The can advantageously facilitate seamless transition to LWA and enhancing user experience.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying figures, in which like reference characters designate like elements.

FIG. 1 illustrates the system and network of an LWA deployment including an exemplary UE capable of autonomously detecting an authentication protocol used by a WLAN AP in accordance with an embodiment of the present disclosure.

FIG. 2 illustrates an exemplary authentication process used by a UE to autonomously detect and authentication type used by a WLAN AP and accordingly authenticate with the AP in accordance with an embodiment of the present disclosure.

FIG. 3 illustrates an exemplary authentication selection process used by a UE to select an authentication process to establish connection with a WLAN AP in accordance with an embodiment of the present disclosure.

FIG. 4 is an exemplary authentication selection process used by a UE to autonomously determine an authentication type and establish connection with a WLAN AP in accordance with an embodiment of the present disclosure.

FIG. 5 illustrates the communication flow among an eNB station, a UE and a WI-FI AP in an LWA activation process in accordance with an embodiment of the present disclosure.

FIG. 6 is a block diagram illustrating the configuration of an exemplary UE device operable to perform a WI-FI authentication selection process to activate LWA data transmission in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications, and equivalents which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. Although a method may be depicted as a sequence of numbered steps for clarity, the numbering does not necessarily dictate the order of the steps. It should be understood that some of the steps may be skipped, performed in parallel, or performed without the requirement of maintaining a strict order of sequence. The drawings showing embodiments of the invention are semi-diagrammatic and not to scale and, particularly, some of the dimensions are for the clarity of presentation and are shown exaggerated in the Figures. Similarly, although the views in the drawings for the ease of description generally show similar orientations, this depiction in the Figures is arbitrary for the most part. Generally, the invention can be operated in any orientation.
LWA Connection With Legacy Wi-Fi Deployment

Embodiments of the present disclosure provide a mechanism for a user equipment (UE) to automatically and autonomously detect an authentication protocol to gain access to a detected wireless local area network (WLAN) and thereby use Long-Term Evolution (LTE)-WLAN Aggregation (LWA). During operation, once the UE receives an instruction from an LTE control station (e.g., an Evolved NodeB (eNB) cell) to connect to a WLAN access point (AP), the UE starts to perform a set of authentication processes that are compliant with different authentication protocols until one is performed that results in successful authentication. In this manner, the UE can autonomously determine an authentication protocol used by a WLAN AP even when the LTE control station is incapable of providing adequate information for purposes of WI-FI authentication.

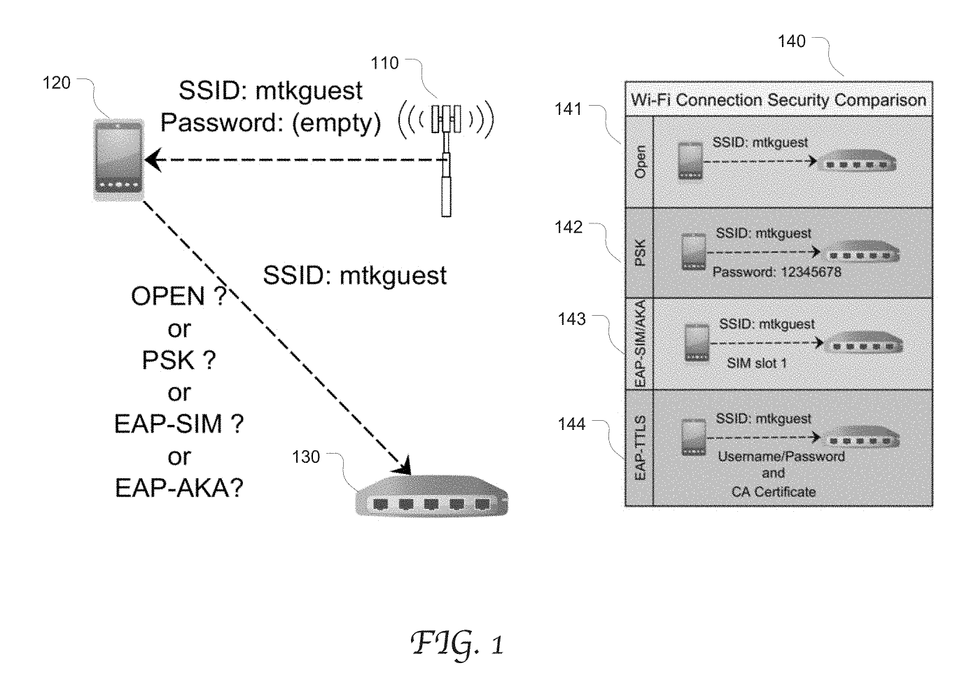

FIG. 1 illustrates the system and network of an LWA deployment 100 including an exemplary UE 120 capable of autonomously detecting an authentication protocol used by a WLAN AP 130 in accordance with an embodiment of the present disclosure. Illustrated in a simplified form, the LWA deployment 100 includes an LTE network, a UE 120 and a WI-FI access point (AP) station 130. The UE 120 and the AP STA 130 are both configured to perform LWA data communication under the control of an LTE operator. The LTE network includes an eNB cell 110 operable to control LWA activation and deactivation for the UE and make various decisions in LWA data communications, e.g., which LTE communication channels are to be offloaded to a WLAN.

To activate LWA for the UE, the eNB station 110 signals the UE 120 to measure surrounding WI-FI APs and report status. In response, the UE 120 performs a WI-FI scan and measurement and reports the results back to the eNB station 110. Provided with the report from the UE, the eNB station 110 sends an Activation Signal Message (ASM) to the UE, which specifies a WLAN AP by the WI-FI Service Set Identifier (SSID), Basic Service Set Identifier (BSSID) and/or Extended Service Set Identifier (ESSID).

Authentication types are tied to the Service Set Identifiers (SSIDs) that are configured for an AP station. One AP may be configured with different types of client devices associated with multiple SSIDs. There are several WI-FI authentication types commonly configured on the WLAN APs, as shown in diagram 140, including the open authentication 141, the Pre-shared Key (PSK) authentication 142, and various Extensible Authentication Protocol (EAPs), such as EAP -Subscriber Identity Module (EAP-SIM) authentication 143, EAP-Authentication and Key Agreement (EAP-AKA) authentication 143, EAP-Authentication and Key Agreement prime (EAP-AKA′) authentication 143, EAP-Tunneled Transport Layer Security (EAP-TTLS) authentication 144, and LWA-specific EAP (EAP-LWA) authentication. This discussion is merely exemplary. It will be appreciated that the present disclosure is not limited to specific authentication types that can be determined by using an authentication selection process in accordance with embodiments of the present disclosure.

More specifically, using open authentication shown in 141, any UE device can authenticate with the AP, but the UE can communicate only if its Wired Equivalent Privacy (WEP) keys match the AP's WEP keys. During PSK authentication 142, the AP sends an unencrypted challenge text string to the UE that is attempting to communicate with the AP. The UE encrypts the challenge text and sends it back to the AP. If the challenge text is encrypted correctly, the AP allows the UE to authenticate.

In EAP Subscriber Identity Module (EAP-SIM) authentication, authentication and session key distribution are achieved by using the subscriber identity module (SIM) registered with the LTE network. EAP-SIM uses a SIM authentication algorithm between the client and an Authentication, Authorization and Accounting (AAA) server providing mutual authentication between the client and the network. This replaces the need for a pre-established password between the client and the AAA server. In EAP-AKA authentication, authentication and session key distribution are achieved by using the Universal Mobile Telecommunications System (UMTS) SIM (USIM) as defined in RFC 4187. EAP-AKA′ authentication is a variant of EAP-AKA as defined in RFC 5448.

The ASM sent from the eNB station does not provide explicit indication of authentication type that a UE can rely upon to authenticate with an identified AP. For open authentication or PSK authentication, the ASM carries adequate indication of the authentication type for the UE. If the AP 130 is configured with open authentication, the UE 120 can authenticate with the AP without the need for a password. If the AP 130 is configured with PSK, the ASM carries a field for WLAN Termination (WT) Counter. Based on detection of a valid WT Counter value in the ASM, the UE 120 can accordingly generate an S-Kwt for WLAN authentication.

The ASM may also carry a general indication of EAP type of an identified AP, but does not specify which particular EAP sub-type. Hence the UE cannot obtain sufficient information from the ASM to decide which particular EAP authentication process should be used to authenticate with the AP. According to embodiments of the present disclosure, the UE is configured to execute a set of authentication processes in search for the authentication type being used by the specified AP, where each process corresponds to a respective authentication type. The set of authentication processes are executed sequentially in a trial-and-error manner until an authentication success occurs and the UE gains access to the WLAN. The authentication type, credential and other relevant information that result in the successful authentication can be stored in a database in association with the AP. Later when the UE attempts to establish connection with the AP again, the stored information can be retrieved and used directly without repeating the authentication selection process.

According to embodiments of the present disclosure, an authentication selection process allows a UE to autonomously and intelligently detect the right authentication protocol used on an AP despite lack of adequate information provided by an eNB node and WI-FI measurements. This can advantageously expand a UE's opportunity and capability of discovering an accessible WLAN and of using the benefits offered by LWA communication. Also, LTE operators can advantageously continue to use legacy WLAN infrastructure configured with EAP-SIM, EAP-AKA and EAP-AKA′ to deploy LWA without the need to upgrade. Further, as the selection process does not require user input or other user intervention, it can be performed transparently to users, thereby advantageously facilitating seamless transition to LWA and enhancing the user experience.

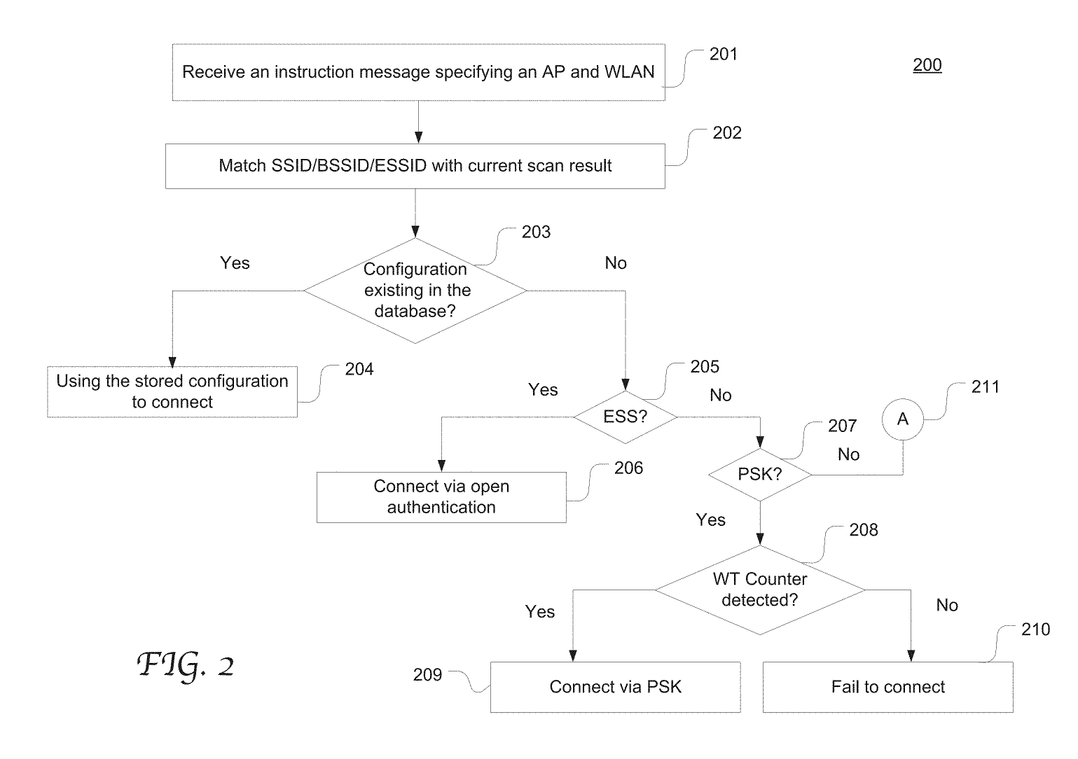

FIG. 2 illustrates an exemplary authentication process 200 used by a UE to autonomously detect the authentication type used by a WLAN AP and accordingly authenticate with the AP in accordance with an embodiment of the present disclosure. At 201, the UE receives an instruction message from the eNB station of an LTE network that provides cellular service to the UE. The message may be generated based on WI-FI scan results that are supplied by the UE and specify a selected WLAN and an AP that serves the WLAN. At 202, the UE searches an authentication database and tries to match the SSID/BSSID/ESSID with the current scan results. The authentication database may be resident locally in the UE or remotely in a server. If the UE determines (at 203) that the authentication configuration for this AP and WLAN is stored in the database, the UE retrieves and applies the stored configuration to execute an authentication process and thereby establishes connection with the AP.

If there is no stored configuration for the identified AP or WLAN, the UE performs an authentication selection process in attempt to search for the matching authentication type. More specifically, the UE first decides (at 205) whether the AP is configured with open authentication. If so, the UE establishes connection with the AP using an open authentication process at 206. If not, the UE then decides whether the AP is configured with PSK authentication at 207.

If it is PSK authentication, the UE further determines (at 208) whether a valid WT counter value is detected in the instruction message. If yes, the UE executes a PSK authentication process at 209 to connect with the AP, including computing an S-Kwt by using the WT counter at 208. However, if no valid WT counter value is detected, the UE declares failure to connect at 210.

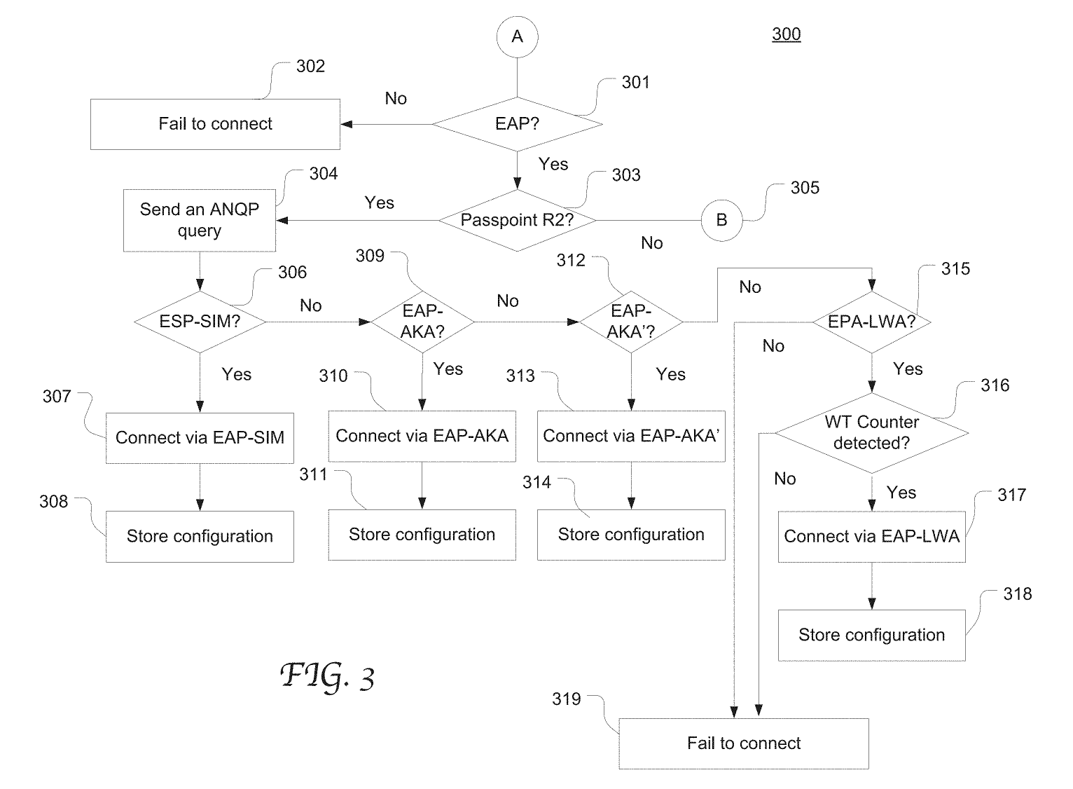

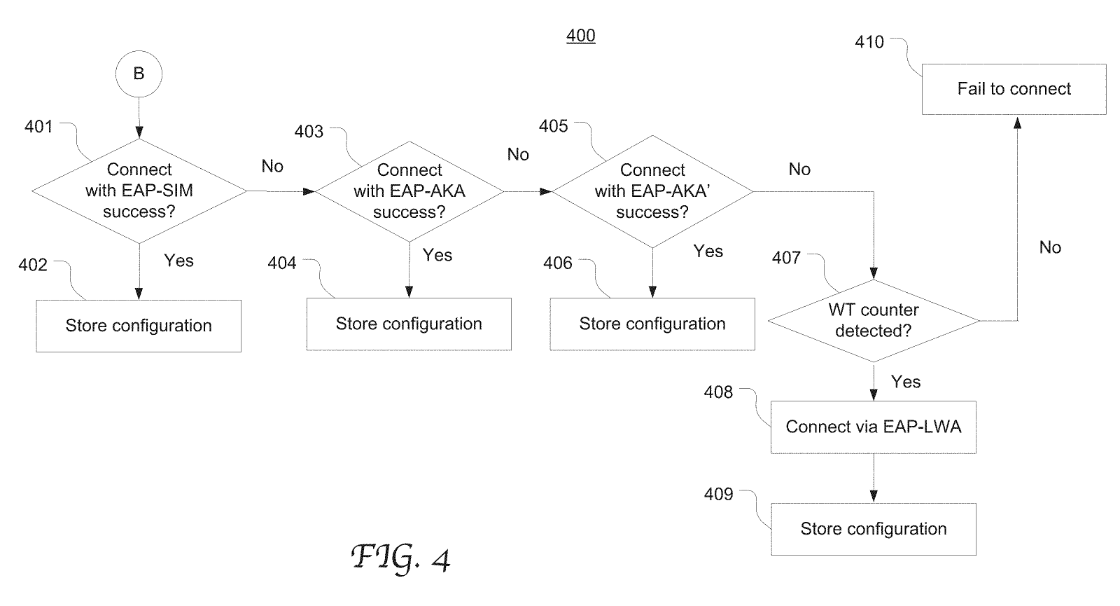

If the UE determines neither open nor PSK authentication is used by the AP, it proceeds to “A” 211 which represents an authentication selection process as described in greater detail with reference to FIGS. 3-4.

FIG. 3 illustrates an exemplary authentication selection process 300 used by a UE to select an authentication process to establish connection with a WLAN AP in accordance with an embodiment of the present disclosure. Process 300 may be performed after it is determined that the AP uses neither open authentication nor PSK authentication as shown in 201-207 of FIG. 2. At 301, the UE further determines whether the AP uses any type of EAP authentication, which may be indicated in the instruction message. If no, the UE declares a failure to connect at 302. If yes, at 303, the UE further determines whether the AP is configured to accept and respond to queries from the UE with regard to authentication information. For example, the UE determines whether the AP supports a Passpoint protocol (e.g., Passpoint Release 2) which the UE uses to submit queries to the AP, e.g., by using the Access Network Query Protocol (ANQP).

If the AP supports Passpoint, the UE sends an ANQP query to inquire about the particular EAP authentication type used by the AP. At 306, based on the ANQP response from the AP, if the UE determines that the AP is configured with EAP-SIM, it executes an EAP-SIM authentication process to establish connection with the AP at 307. At 308, the EAP-SIM authentication configuration is stored in the database in association with the SSID/BSSID/ESSID for future use.

If the query response indicates that the AP is configured with EAP-AKA (as determined at 309), the UE executes an EAP-AKA authentication process to establish connection with the AP at 310. At 311, the EAP-AKA authentication configuration in association with the SSID/BSSID/ESSID is stored to the database. Similarly, if the response indicates that the AP is configured with EAP-AKA′ (as determined at 312), the UE executes an EAP-AKA′ authentication process to establish connection with the AP at 313. At 314, the EAP-AKA′ authentication configuration in association with the SSID/BSSID/ESSID is stored to the database.

If the query response indicates that the AP is configured with EAP-LWA authentication at 315 and a WT counter is detected from the instruction message as determined at 316, the UE executes an EAP-LWA authentication process to establish connection with the AP at 317. At 311, the EAP-LWA authentication configuration in association with the SSID/BSSID/ESSID is stored in the database. However, if no WT counter is detected, the UE declares failure to connect at 319.

If, at 303, the UE determines that the AP does not support Passpoint and therefore the authentication type cannot be obtained by querying the AP, the UE proceeds to perform “B” 305 as described in greater detail with reference to FIG. 4.

FIG. 4 is an exemplary authentication selection process 400 used by a UE to autonomously determine an authentication type and to establish connection with a WLAN AP in accordance with an embodiment of the present disclosure. Process 400 may be invoked after the UE determines that the authentication type of the AP cannot be determined based on the ASM message or a query for example. At 401, the UE executes an EAP-SIM authentication process with the AP. If the authentication is successful, the configuration of the EAP-SIM authentication in association with the SSID/BSSID/ESSID is stored in the database for future use. If not, at 403, the UE executes an EAP-AKA authentication process with the AP. If the authentication is successful at 403, the configuration of the EAP-AKA authentication associated with the SSID/BSSID/ESSID is stored in the database. However, if the authentication still fails at 403, the UE executes an EAP-AKA′ authentication process with the AP. If the authentication is successful at 405, the configuration of the EAP-AKA authentication in association with the SSID/BSSID/ESSID is stored in the database. If the authentication still fails at 405, the UE determines (at 407) if the instruction message provides a valid WT counter. If yes, the UE executes an EAP-LWA authentication process with the AP. The configuration of the EAP-LWA authentication in association with the SSID/BSSID/ESSID is stored in the database at 409. However, if no valid WT counter is detected, the UE declares failure to connect at 410.

Processes 200, 300 and 400 may be implemented in software logic, hardware logic, firmware logic or a combination thereof. It will be appreciated that the present disclosure is not limited to any specific order to execute a set of authentication processes in search for a matching authentication type used by an AP. Nor is it limited to specific authentication protocols embodied in the authentication processes. The authentication selection process can be performed in conjunction with any other suitable authentication process that is well known in the art.

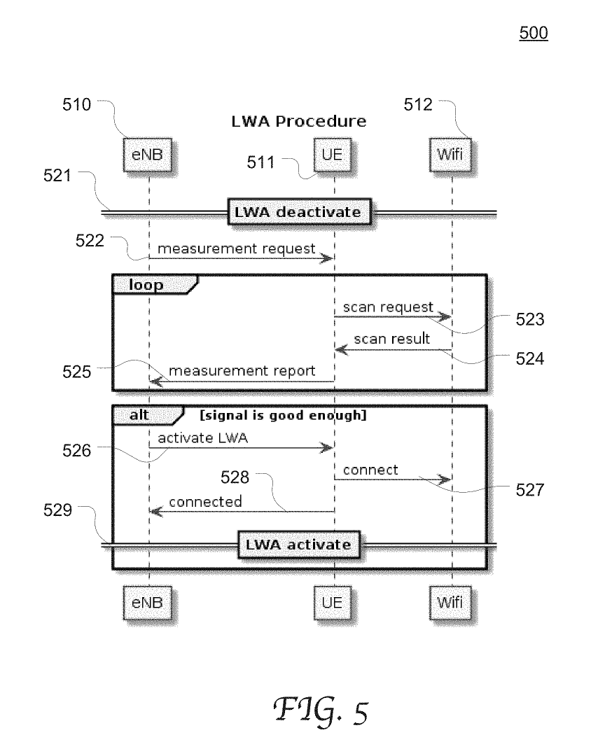

FIG. 5 illustrates the communication flow among an eNB station 510, a UE 511 and a WI-FI AP 512 in an LWA activation process in accordance with an embodiment of the present disclosure. Starting from a state 521 in which LWA is deactivated, a cell of the eNB station 510 sends a measurement request (at 522) to signal the UE 511 to perform WI-FI scan, measure surrounding WI-FI APs and report measurement results. During the WI-FI scan, the UE 511 sends scan requests to one or more detected WI-FI APs at 523 and collects scan results from the APs at 524. The UE then sends the scan results in a measurement report to the eNB 510.

If a scan result indicates acceptable WI-FI signals, at 526, the eNB station 510 sends an ASM to trigger the UE 511 to connect the associated WI-FI AP. The ASM may include WII-FI SSID/BSSID/ESSID and a WT counter if the AP is configured with the PSK authentication. The UE 511 executes an authentication process to authenticate with the WI-FI AP at 527 and thereby gain access to the WI-FI, as described in greater detail with reference to FIGS. 2-4. The UE then reports to the eNB 510 about the successful connection with the WI-FI. As a result, the eNB activates LWA communication for the UE. That is, data packets can be transmitted to and from the UE by aggregating the LTE links and the WI-FI links simultaneously.

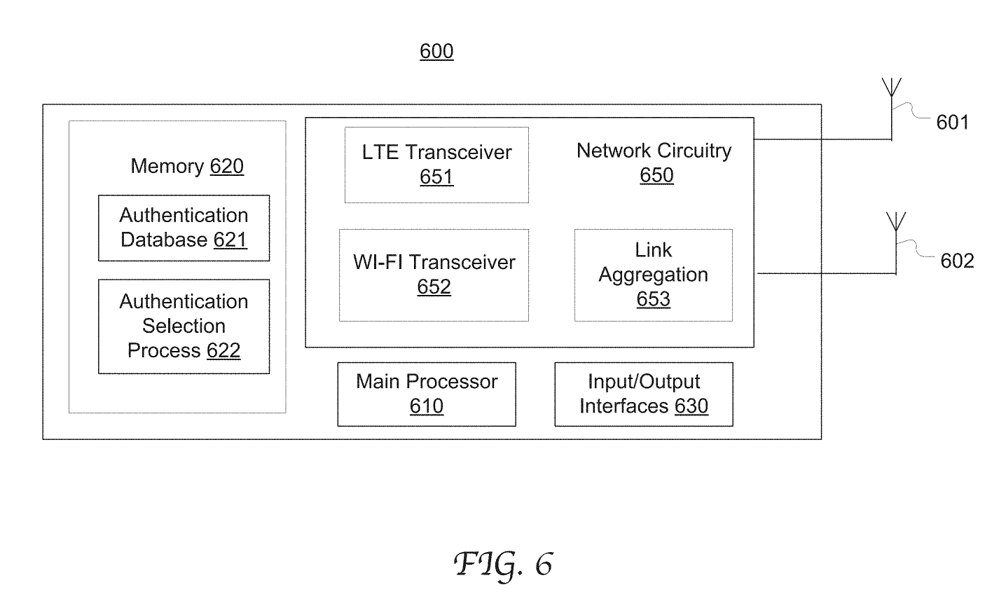

FIG. 6 is a block diagram illustrating the configuration of an exemplary UE device 600 operable to perform a WI-FI authentication selection process to activate LWA data transmission in accordance with an embodiment of the present disclosure. The device 600 may be a general-purpose computer or any other type of computing device or network device, such as a server, a smart phone, a tablet, a game console, a desktop, a laptop and so on.

The UE includes a main processor 530 which may be a central processing unit (CPU) and a graphics processing unit (GPU), a memory 620 and network circuits 650 coupled to an array of antennas 601 and 602. The network circuits 650 include a cellular network transceiver, e.g., LTE transceiver 651 configured to be coupled to an LTE network for data communication through LTE links. The network circuits 650 also include a WI-FI transceiver 652 operable to be coupled with a WI-FI AP for data communication through WI-FI links. The link aggregation module 653 is configured to aggregate LTE links and WI-FI links for LWA data transmission. Each of the LTE transceiver 651 and the WI-FI transceiver 652 includes its own signal processor for a transmit path and a receive path.

The memory 620 stores an authentication database 621 including the saved configurations specific to various authentication processes as well as specific to a plurality of identified WLANs and APs. The memory 620 further stores processor-executable instructions that implement an authentication selection process 622, through which the UE can detect and execute an authentication process to gain access to a detected WLAN for LWA data communication, as described in greater detail with reference to FIGS. 1-5 above. It will be appreciated that the UE 600 may include a wide range of other suitable components that are well known in the art and can be implemented in any suitable manner that is well known in the art.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

1. A method of wireless communication, said method comprising:
at a wireless communication device, receiving a message transmitted from a Radio Access Network (RAN) node that is controlled by a cellular network, wherein said message comprises an instruction for said wireless communication device to access a first identified wireless local area network (WLAN);
responsive to said instruction, sequentially executing a set of authentication processes for accessing said first identified WLAN until successful authentication results, wherein each authentication process of said set of authentication processes corresponds to a different authentication protocol; and
following said successful authentication, transmitting or receiving a data stream by aggregating communication channels of said first identified WLAN and said cellular network simultaneously.

2. The method of claim 1, wherein said cellular network is a Long-Term Evolution (LTE) network, and wherein further said RAN node comprises an Evolved Node B (eNB) station.

3. The method of claim 1, wherein said set of authentication processes comprises two or more of: an Extensible Authentication Protocol (EAP)-Subscriber Identity Module (EAP-SIM) authentication process; an EAP-Authentication and Key Agreement (EAP-AKA) authentication process; an EAP-AKA prime (EAP-AKA′) authentication process; and an EAP-LTE-WLAN-Aggregation (EAP-LWA) authentication process.

4. The method of claim 3 further comprising, responsive to detection of a WLAN Termination Counter (WT counter) in an Activation Signal Message (ASM), executing a Pre-Shared Key (PSK) authentication process.

5. The method of claim 3 further comprising, based on said successful authentication, storing an authentication configuration used to access said first identified WLAN, wherein said authentication configuration specifies an authentication protocol and an authentication credential.

6. The method of claim 5 further comprising:
performing a WI-FI scan;
sending WI-FI scan results to said RAN node; and
based on an ID of a second identified WLAN specified in an Activation Signal Message (ASM), retrieving a stored authentication configuration associated with said second identified WLAN from a database.

7. The method of claim 3, further comprising:
determining that a third identified WLAN is compatible with an Access Network Query Protocol (ANQP); and
determining an authentication process by sending an ANQP query to an access point of said WLAN.

8. A wireless communication device comprising
a memory;
network circuits configured to be coupled to a cellular network and a wireless local area network (WLAN);
a processor coupled to said memory and said network circuits, wherein said memory stores instructions that, when executed by said processor, cause said wireless communication device to perform a method of communication comprising:
receiving a message transmitted from a Radio Access Network (RAN) node that is controlled by said cellular network, wherein said message comprises an instruction for said wireless communication device to access a first identified wireless local area network (WLAN);
responsive to said instruction, sequentially executing a set of authentication processes for accessing said first identified WLAN until successful authentication results, wherein each said set of authentication processes corresponds to a different authentication protocol; and
following said successful authentication, transmitting or receiving a data stream by using communication channels of said first identified WLAN and said cellular network simultaneously.

9. The wireless communication device of claim 8, wherein said cellular network is a Long-Term Evolution (LTE) network, and wherein said RAN node comprises an Evolved Node B (eNB) station.

10. The wireless communication device of claim 8, wherein said set of authentication processes comprises two or more of: an Extensible Authentication Protocol (EAP)-Subscriber Identity Module (EAP-SIM) authentication process; an EAP-Authentication and Key Agreement (EAP-AKA) authentication process; an EAP-AKA prime (EAP-AKA′) authentication process; and an EAP-LTE-WLAN-Aggregation (EAP-LWA) authentication process.

11. The wireless communication device of claim 10, wherein said method further comprises, responsive to detection of a WLAN Termination Counter (WT counter) in an Activation Signal Message (ASM), executing a Pre-Shared Key (PSK) authentication process.

12. The wireless communication device of claim 10, wherein said method further comprises, based on said successful authentication, storing an authentication configuration used to access said first identified WLAN, wherein said authentication configuration specifies an authentication protocol and an authentication credential.

13. The wireless communication device of claim 10, wherein said method further comprises:
performing a WI-FI scan;
sending WI-FI scan results to said RAN node; and
based on an ID of a second identified WLAN specified in an Activation Signal Message (ASM), retrieving a stored authentication configuration associated with said second identified WLAN from a database.

14. The wireless communication device of claim 10, wherein said method further comprises:
determining that a third identified WLAN based on an Activation Signal Message (ASM) is compatible with an Access Network Query Protocol (ANQP); and
determining an authentication process based on an ANQP query, wherein said authentication process is selected from one of: an EAP-SIM authentication process; an EAP-AKA authentication process; an EAP-AKA′ authentication process; and an EAP-LTE-WLAN-Aggregation (EAP-LWA) authentication process.

15. A non-transitory computer-readable storage medium embodying instructions that, when executed by a processing device of a wireless communication device, cause said wireless communication device to perform a method of communication comprising:
receiving a message transmitted from a Radio Access Network (RAN) node that is controlled by a cellular network, wherein said message comprises an instruction for said wireless communication device to access a first identified wireless local area network (WLAN);
responsive to said instruction, sequentially executing a set of authentication processes to authenticate with an access point of said first identified WLAN until successful authentication results; and
following said successful authentication, transmitting or receiving a data stream by using communication channels of said first identified WLAN and said cellular network simultaneously.

16. The non-transitory computer-readable storage medium of claim 15, wherein said cellular network is a Long-Term Evolution (LTE) network, and wherein said RAN node comprises an Evolved Node B (eNB) station.

17. The non-transitory computer-readable storage medium of claim 15, wherein said set of authentication processes comprise two or more of: an Extensible Authentication Protocol (EAP)-Subscriber Identity Module (EAP-SIM) authentication process; an EAP-Authentication and Key Agreement (EAP-AKA) authentication process; an EAP-AKA prime (EAP-AKA′) authentication process; and an EAP-LTE-WLAN-Aggregation (EAP-LWA) authentication process.

18. The non-transitory computer-readable storage medium of claim 15, wherein said method further comprises, responsive to detection of a WLAN Termination Counter (WT counter) in an Activation Signal Message (ASM), performing a Pre-Shared Key (PSK) authentication process.

19. The non-transitory computer-readable storage medium of claim 18, wherein said method further comprises, based on said successful authentication, storing an authentication configuration used to access said first identified WLAN, wherein said authentication configuration specifies an authentication protocol and an authentication credential.

20. The non-transitory computer-readable storage medium of claim 18, wherein said method further comprises:
performing a WI-FI scan;
sending WI-FI scan results to said RAN node; and
based on an ID of a second identified WLAN specified in an ASM, retrieving a stored authentication configuration associated with said second identified WLAN from a database.

21. The non-transitory computer-readable storage medium of claim 18, wherein said method further comprises:
determining that a third identified WLAN is compatible with an Access Network Query Protocol (ANQP); and
determining an authentication process based on an ANQP query, wherein said authentication process is selected from one of: an EAP-SIM authentication process; an EAP-AKA authentication process; EAP-AKA′ authentication process; and an EAP-LTE-WLAN-Aggregation (EAP-LWA) authentication process.
